(19) United States
(12) Patent Application Publication
(10) Pub. No.: US 2005/0249547 A1
(43) Pub. Date: Nov. 10, 2005

(54) Combinable wooden block

(76) Inventor: Chen Chang Chang, Sijhih City (TW)

Correspondence Address: TROXELL LAW OFFICE PLLC, 5205 LEESBURG PIKE, SUITE 1404, FALLS CHURCH, VA, 22041, US

(21) Appl. No.: 10/841,638

(22) Filed: May 10, 2004

(51) Int. Cl. F16D 1/00

(52) U.S. Cl. 403/169

(57) ABSTRACT

A combinable wooden block includes a rectangular, a circular or a triangular plate body having its peripheral side wall provided with at least two insert studs spaced apart equidistantly and extending outward transversely. Each insert stud is bored with a positioning groove in the central portion of its outer end. The plate body is bored in the center with a through insert hole having its inner wall secured with two symmetrical positioning projections. Thus, any of the insert studs of one wooden block can be inserted in the insert hole of another wooden block to let the positioning groove of the insert stud and the two positioned projection2s in the insert hole engaged with each other, able to be quickly and firmly combined into various shapes.

### BACKGROUND OF THE INVENTION

1. Field of the Invention

This invention relates to a combinable wooden block, particularly to one having a multiple-shaped plate body provided with at least two insert studs on the peripheral side wall and an insert hole in the center, able to be mutually combined into various shapes.

2. Description of the Prior Art

Generally speaking, combinable wooden blocks have a function of cultivating children in the concept of shapes and digits, such as traction, odd numbers, even numbers and multiples; therefore, combinable wooden blocks are widely employed as teaching aids for children about the theory and concept of mathematics and also training them to cleverly use their hands in the course of combination of wooden blocks.

For the present, most wooden blocks are solid block-shaped or hollow block-shaped or slice-shaped, able to be combined with each other by mutual engagement of their peripheral side walls.

Conventional wooden blocks, whether block-shaped or slice-shaped, are monotonous in shapes and deficient in transmutability of combination. Additionally, the conventional wooden blocks can be combined with one another only by mutual engagement of their peripheral side walls often in unstable conditions, unable to be combined with one another in different directions, failing to be combined into a shape with 3D and impossible to be turned to keep the combination firmly.

### SUMMARY OF THE INVENTION

The objective of the invention is to offer a combinable wooden block having a rectangular or circular or triangular plate body. The plate body has its peripheral side wall provided with a least two insert studs spaced apart equidistantly and extending outward transversely, and each insert stud has the central portion of its outer end cut with a positioning groove. The plate body is further bored in the center with an insert hole having its inner wall provided with two symmetrical positioning projections. Thus, every two wooden blocks can be combined with each other by inserting the insert stud in the insert hole and the two positioning projections in the insert hole engaged with the positioning groove of the insert stud, able to be stably combined into various shapes in different directions.

### BRIEF DESCRIPTION OF DRAWINGS

This invention will be better understood by referring to the accompanying drawings, wherein:

FIG. 1 is a perspective view of a first preferred embodiment of a combinable wooden block in the present invention:

FIG. 2 is a rear cross-sectional view of the first preferred embodiment of the combinable wooden block in the present invention:

FIG. 3 is a cross-sectional view of the first preferred embodiment of the combinable wooden blocks combined with each other in the present invention:

FIG. 4 is a perspective view of a second preferred embodiment of the combinable wooden block in the present invention:

FIG. 5 is a rear view of the second preferred embodiment of the combinable wooden block in the present invention:

FIG. 6 is a cross-sectional view of the two combinable wooden blocks of the second embodiment combined with each other in the present invention:

FIG. 7 is a perspective view of a third preferred embodiment of the combinable wooden block in the present invention:

FIG. 8 is a rear view of the third preferred embodiment of the combinable wooden block in the present invention:

FIG. 9 is a cross-sectional view of the two combinable wooden blocks of the third embodiment combined with each other in the present invention: and

FIG. 10 is a perspective view of the first, the second and the third preferred embodiment of the combinable wooden blocks combined with one another in the present invention.

### DETAILED DESCRIPTION OF THE PREFERRED EMBODIMENT

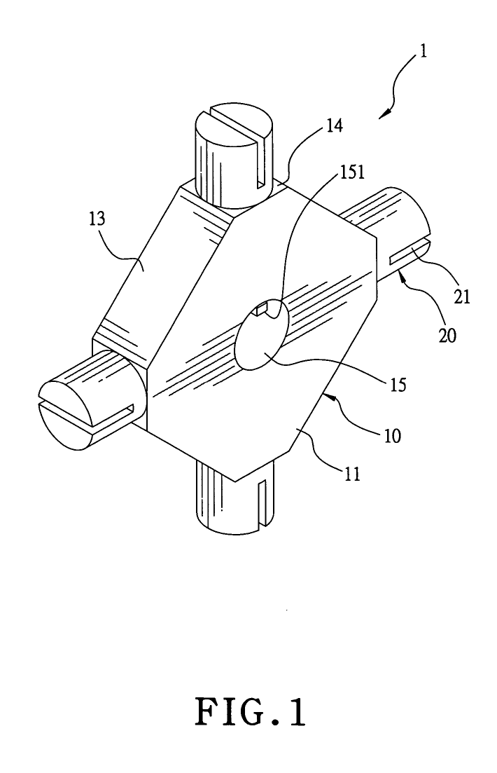

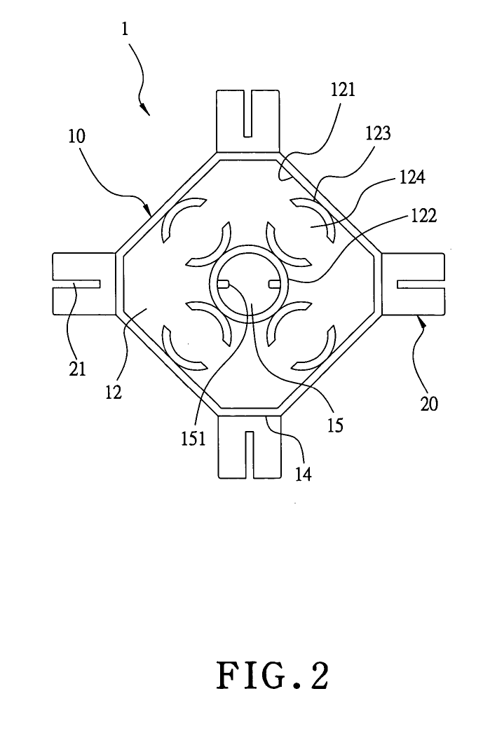

A first preferred embodiment of a combinable wooden block 1 in the present invention, as shown in FIGS. 1 and 2, includes a rectangular plate body 10 having its front and rear side respectively formed with a flat surface 11 and a recessed surface 12. The combinable wooden block 1 has its peripheral side formed with four rectangular side walls 13, with the four angular corners of the four side walls 13 respectively formed with a truncated plane 14 secured thereon with insert stud 20 extending straightly outward. Each insert stud 20 has the central portion of its outer end cut with a positioning groove 21 with a preset depth with its cut direction exactly right-angled to the truncated surface 14. The flat surface 11 of the plane body 10 is bored in the center with a through insert hole 15 having its inner wall provided with two symmetrical positioning flanges 151. Thus, after any insert stud 20 of a first wooden block 1 is inserted in the insert hole 15 of a second wooden block 1, the positioning groove 21 of the insert stud 20 of the first wooden block 1 can be exactly engaged with the two positioning projections 151 in the insert hole 15 of the second wooden block 1. The recessed surface 12 of the plate body 10 is provided with an outer groove wall 121 around the edge of its outer circumferential wall and an inner groove wall 122 around the outer circumferential edge of the insert hole 15. Further, the plate body 10 has the recessed surface 12 between two adjacent insert studs 20 provided with two opposed crescent-shaped reinforcing ribs 123 respectively connected with the inner and the outer groove wall 122, 121 and together forming a circular insert groove 124 for the insert stud 20 to be inserted and positioned therein.

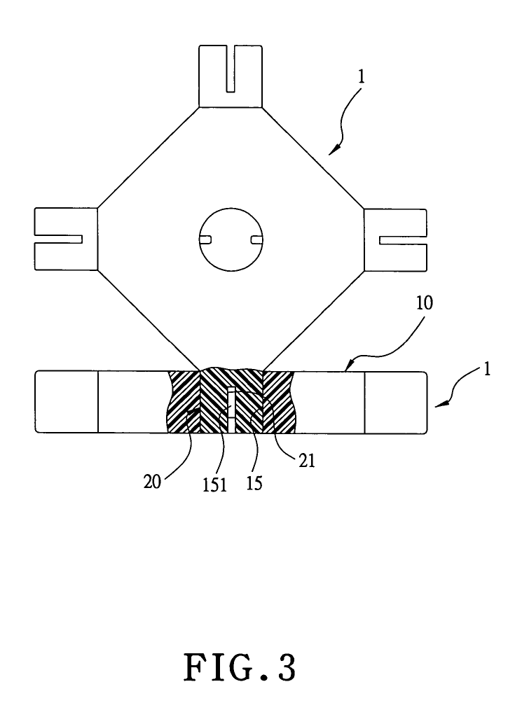

In combining, as shown in FIG. 3, firstly, a first wooden block 1 has any of its four insert studs 20 facing the central insert hole 15 of the plate body 10 of a second wooden block 1, letting the positioning groove 21 of the insert stud 20 aligned to the two symmetrical positioning projections 151. Then, the insert stud 20 of the first wooden block 1 is inserted in the insert hole 15 of the second wooden block 1 and let the positioning groove 21 of the insert stud 20 and the positioning projections 151 in the insert hole 15 engaged with each other, enabling every two wooden blocks 1 to be mutually combined in specific directions. In this way the combinable wooden blocks 1 can be mutually combined into various shapes.

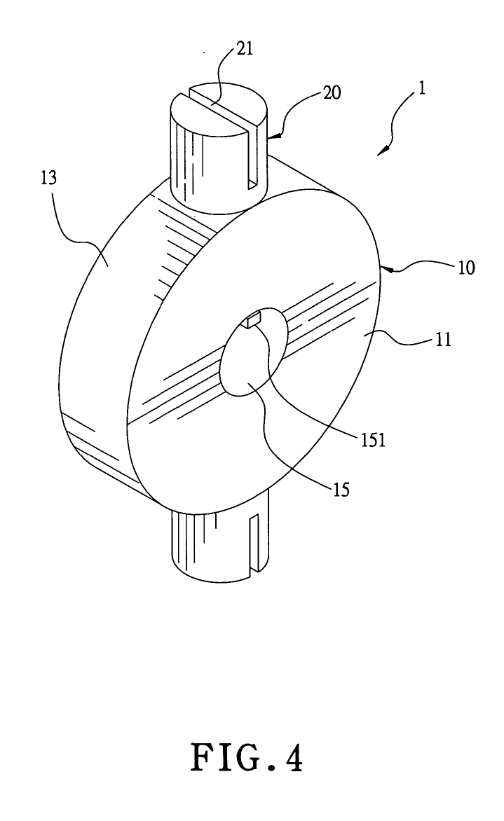

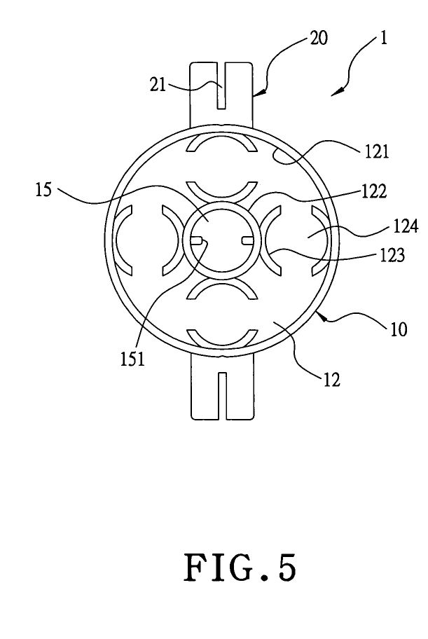

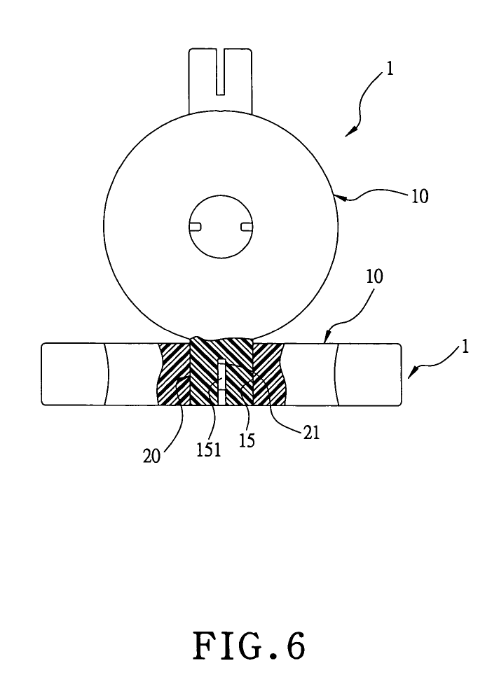

A second preferred embodiment of a combinable wooden block 1 in the present invention, as shown in FIGS. 4 and 5, includes a circular plate body 10 having two symmetrical insert studs 20 provided on its peripheral side wall 13 and extending outward diametrically, and each insert stud 20 has the central portion of its outer end cut with a positioning groove. The circular plate body 10 is bored in the center with an insert hole 15 having its inner wall fixed with two symmetrical positioning projections 151. Thus, any of the insert studs 20 of a first wooden block 1 can be inserted in the insert hole 15 of a second wooden block 1, letting the positioning groove 21 of the insert stud 20 and the two positioning flanges 151 in the insert hole 15 firmly engaged with each other, as shown in FIG. 6. In this way the combinable wooden blocks 1 can be combined into any shape as one pleases.

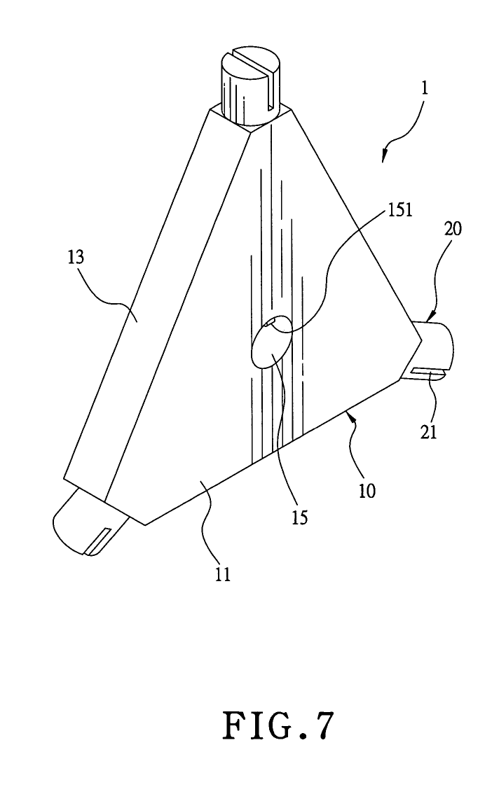

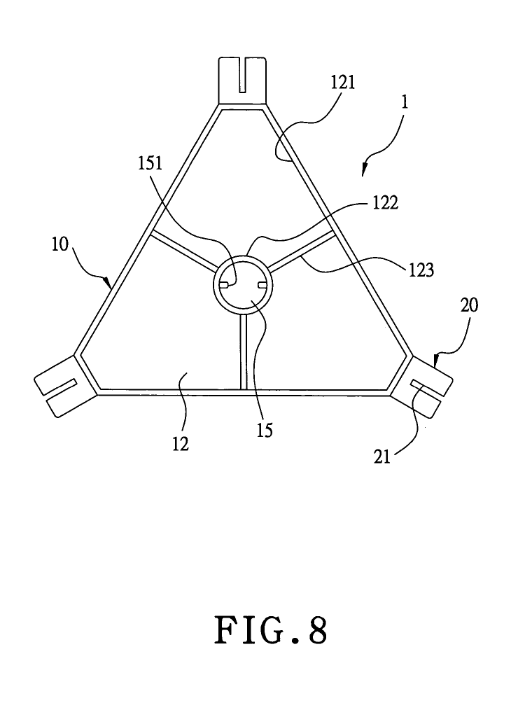

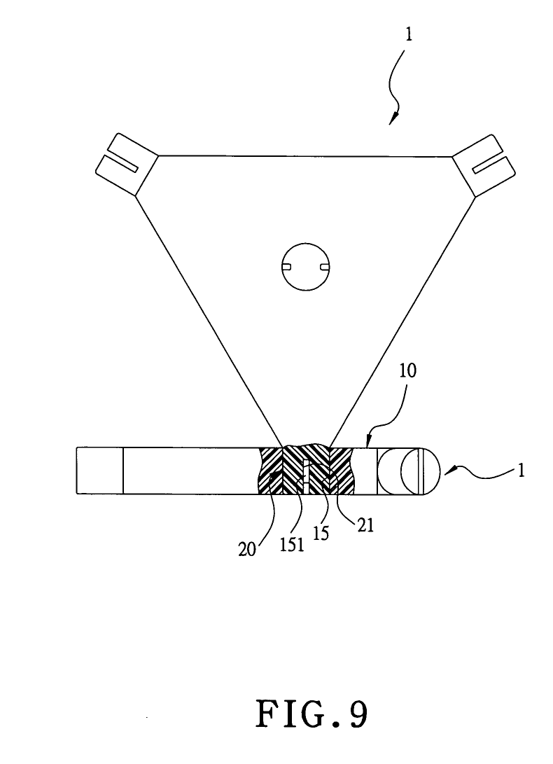

A third preferred embodiment of a combinable wooden block 1 in the present invention, as shown in FIGS. 7 and 8, includes a triangular plate body 10 having its three angular corners of its peripheral side wall 13 respectively formed with a truncated plane 14 secured thereon with an insert stud 20 extending straightly outward. The plate body 10 has its flat surface 11 bored with an insert hole 15 in the center and its recessed surface 12 provided with three elongate reinforcing ribs 123 respectively positioned between its outer groove wall 121 and its inner groove wall 122. Thus, any of the insert studs 20 of a first wooden block 1 can be inserted in the insert hole 15 of a second wooden block 1, letting the positioning groove 21 of the insert 20 and the positioning projections 151 in the insert hole 15 firmly engaged with each other, as shown in FIG. 9. In this way the combinable wooden blocks 1 of the third embodiment can be mutually combined into any shape as one wishes.

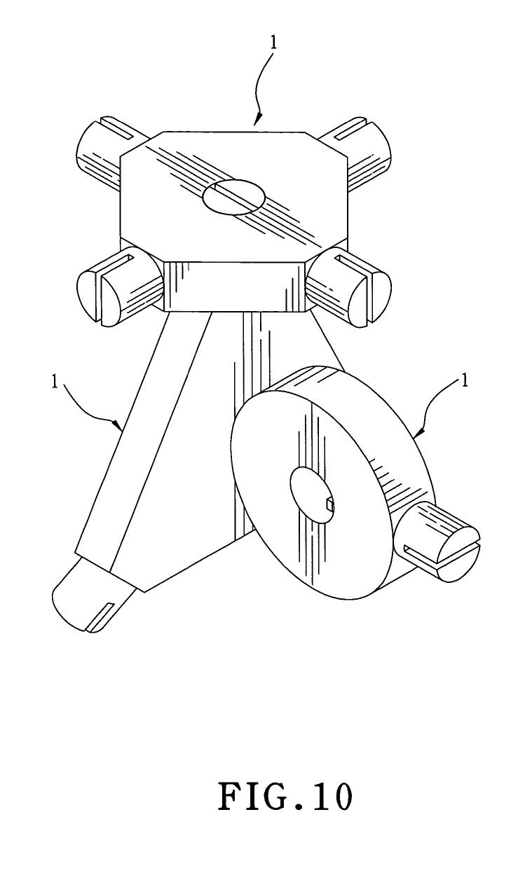

In addition, the different-shaped wooden blocks 1 of the first, the second and the third preferred embodiment can freely be matched to be combined into different shapes, as shown in FIG. 10.

To sum up, the combinable wooden block in the present invention has the following advantages.

1. The plate body 10 of the wooden block 1 is formed with various shapes, increasing transmutability in combination.

2. The numbers and the locations of the insert studs 20 of the wooden block 1 can be changed according to different shapes of the plate body 1, elevating variation of combination.

3. The wooden block 1 is provided with insert studs 20 on the peripheral side wall and an insert hole 15 in the center; therefore, the wooden blocks 1 can be combined with one another in different directions, able to be combined into a shape with 3D.

4. The insert stud 20 of the wooden block 1 has its front end cut with a positioning groove 21, and the insert hole 15 has its inner wall secured with two symmetrical positioning projections 151, enabling the wooden blocks 1 to be mutually combined in certain directions and having stability in structure.

While the preferred embodiments of the invention have been described above, it will be recognized and understood that various modification s may be made therein and the appended claims are intended to cover all such modifications that may fall within the spirit and scope of the invention.

1. A combinable wooden block comprising a plate body, said plate body having a peripheral side wall with a preset shape, said plate body having at least one side formed with a flat surface, said peripheral side wall of said plate body provided thereon with at least two insert studs extending outward vertically and spaced apart equidistantly, each said insert stud having the central portion of its outer end cut with a positioning groove with a preset depth, said plate body further bored with a through insert hole in the center, said insert hole having its inner wall provided with two symmetrical positioning projections, any of said insert studs of a first wooden block able to be inserted in said insert hole of a second wooden block, said positioning groove of said insert stud of said first wooden block and said positioning flanges in said insert hole of said second wooden block able to be firmly and quickly engaged with each other.

2. The combinable wooden block as claimed in claim 1, wherein said plate body is rectangular, having its four angular corners respectively formed with a truncated plane secured thereon with an insert stud extending straightly outward.

3. The combinable wooden block as claimed in claim 1, wherein said plate body is a circular body having it peripheral side wall provided with two symmetrical insert studs extending outward diametrically.

4. The combinable wooden block as claimed in claim 1, wherein said plate body is triangular, having its three angular corners respectively formed with a truncated plane secured thereon with an insert stud extending straightly outward.

5. The combinable wooden block as claimed in claim 1, wherein said plate body has one side formed with a flat surface and the other side formed with a recessed surface having plural reinforcing ribs fixed at preset locations.

6. The combinable wooden block a claimed in claim 5, wherein each said reinforcing rib is crescent-shaped and every two said reinforcing ribs are positioned oppositely to form a circular insert groove for said insert stud to be inserted and positioned therein.
